(19) United States
(12) Patent Application Publication
(10) Pub. No.: US 2014/0161989 A1
(43) Pub. Date: Jun. 12, 2014

(54) Anti-Glare Using a Two-Step Texturing Process

(71) Applicant: INTERMOLECULAR, INC., San Jose, CA (US)

(72) Inventors: Nikhil Kalyankar, Mountain View, CA (US); Scott Jewhurst, Redwood City, CA (US); Minh Huu Le, San Jose, CA (US)

(73) Assignee: INTERMOLECULAR, INC., San Jose, CA (US)

(21) Appl. No.: 13/712,048

(22) Filed: Dec. 12, 2012

(51) Int. Cl. B05D 5/06

(52) U.S. Cl. CPC B05D 5/061; B82Y 30/00
USPC 427/558; 427/162; 977/773

(57) ABSTRACT

Methods for forming anti-glare coatings including forming a layer using a sol-gel process are described. The layer further includes at least one of porogens, nanoparticles, or photosensitive macromolecules. The porogens, nanoparticles, or photosensitive macromolecules are removed using a thermal treatment or UV treatment to impart porosity and surface roughness to the layer. Alternatively, the layer may be roughened using a mechanical process. The layer can optionally be subjected to a curing step. The curing step may be a thermal curing process or a chemical curing process.

### TECHNICAL FIELD

The present invention relates to optical coatings. More particularly, this invention relates to optical coatings that improve, for example, the anti-glare performance of transparent substrates and methods for forming such optical coatings.

### BACKGROUND

Anti-glare coatings, and anti-glare panels in general, are desirable in many applications including semiconductor device manufacturing, solar cell manufacturing, glass manufacturing, and display screen manufacturing. Such optical coatings scatter specular reflections into a wide viewing cone to diffuse glare and reflection. It is difficult to achieve a substrate that simultaneously reduces gloss (i.e., specular reflection) and haze (i.e., diffuse transmittance) while relying on light scattering to obtain anti-glare properties.

Conventional methods of forming anti-glare panels include, for example, wet etching the surface of the substrate, using mechanical rollers with pre-defined textures on substrates to create a surface roughness, and applying thin, polymeric films with texture to the substrates using adhesives. Such methods are expensive, have low throughput (i.e., a low rate of manufacture), and lack precise control with respect to surface texture, which results in a diffuse scattering coating with poor light transmittance. Additionally, coatings formed using the polymeric films often demonstrate poor abrasion resistance and cohesive strength, resulting in the coatings (and/or the substrate itself) being damaged when various forces are experienced.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

In some embodiments, methods for forming anti-glare coatings including forming a layer using a sol-gel process are described. The layer further includes at least one of porogens, nanoparticles, or photosensitive macromolecules. The porogens, nanoparticles, or photosensitive macromolecules are removed using a thermal treatment or UV treatment to impart porosity and surface roughness to the layer. Alternatively, the layer may be roughened using a mechanical process. The layer can optionally be subjected to a curing step. The curing step may be a thermal curing process or a chemical curing process.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 illustrates a flow chart describing methods of some embodiments.

FIG. 2 illustrates a cross-sectional schematic of a substrate with a layer formed thereon.

FIG. 3 illustrates a cross-sectional schematic of a substrate with a layer formed thereon.

FIG. 4 illustrates a cross-sectional schematic of a substrate with a layer formed thereon.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, methods of making a sol-gel composition are provided. The methods comprise mixing a film forming precursor, an acid or base containing catalyst, water, an alcohol containing solvent, and optionally silicon oxide nanoparticles to form a reaction mixture by at least one of a hydrolysis or polycondensation reaction, and subsequently adding a solidifier to the reaction mixture.

In some embodiments, compositions for forming a sol-gel system are provided. The compositions comprise a film forming precursor, an acid or base containing catalyst, an alcohol containing solvent, a solidifier, and water.

The term “gel” as used herein is a coating that has both liquid and solid characteristics and may exhibit an organized material structure.

The term “molecular porogen” as used herein is any chemical compound capable of forming a sol-gel composition which burns off upon combustion to form a void space or pore in a porous coating.

The term “self assembling molecular porogen” as used herein is a molecular porogen, generally comprising surfactant molecules, which adopts a defined arrangement without guidance or management from an outside source. Assembly is generally directed through noncovalent interactions as well as electromagnetic interactions. One example is the formation of micelles by surfactant molecules above a critical micelle concentration.

The term “sol-gel composition” as used herein is a chemical solution comprising at least a film forming precursor and a solidifier. The film forming precursor forms a polymer which upon annealing forms a coating.

The term “sol-gel process” as used herein is a process where a wet formulation (the “sol”) is dried to form a gel coating having both liquid and solid characteristics. The gel coating is then heat treated to form a solid material. The gel coating or the solid material may be formed by applying a thermal treatment to the sol. This technique is valuable for the development of coatings because it is easy to implement and provides films of uniform composition and thickness.

The term “sol-gel transition point” as used herein refers to the transition of a sol to a gel at the gel point. The gel point may be defined as the point at which an infinite polymer network first appears. At the gel point, the sol becomes an Alcogel or wet gel.

The term “solidifier” as used herein refers to any chemical compound that expedites the occurrence of the sol-gel transition point. It is believed that the solidifier increases the viscosity of the sol to form a gel.

The term “surfactant” as used herein is an organic compound that lowers the surface tension of a liquid and contains both hydrophobic groups and hydrophilic groups. Thus the surfactant contains both a water insoluble component and a water soluble component.

Some methods of depositing coatings on substrates include the use of sol-gels. Sol-gel processes are those where a wet formulation (the “sol”) is dried to form a gel coating having both liquid and solid characteristics. The sol is mostly liquid based, with the components of the sol evenly distributed in the sol system. The gel coating is then treated to form a solid material. The gel coating or the solid material may be formed by applying a thermal treatment to the sol.

As the sol is dried to form the gel, the sol goes through a sol-gel transition point where the system goes from a low viscosity mostly liquid system to a high viscosity system which is mostly gel. The “sol-gel transition point” may be defined as the transition of a sol to a gel at the gel point. The gel point may be defined as the point at which an infinite polymer network first appears. At the gel point, the sol becomes an Alcogel or wet gel.

In addition to the solidifier, the sol-gel composition further includes a film forming precursor which forms the primary structure of the gel and the resulting solid coating. Exemplary film forming precursors include silicon containing precursor, a titanium containing precursor, or an aluminum containing precursor, a zirconium containing precursor, a tantalum containing precursor, a hafnium containing precursor, a tin containing precursor, and the like. The sol-gel composition may further include alcohol and water as the solvent system, and either an inorganic or organic acid or base as a catalyst or accelerator. In some embodiments, where it is desirable to form a porous coating, the sol-gel composition may further include at least one of a porosity forming agent and nanoparticles such as silica nanoparticles. A combination of the aforementioned chemicals leads to a composition called a sol-gel through hydrolysis and condensation reactions. Exemplary coating techniques for applying the sol-gel compositions described herein onto a substrate include dip-coating, spin coating, spray coating and curtain coating. The deposited thin films may then be heat treated to remove excess solvent, and annealed at an elevated temperature to create a polymerized network (e.g., —Si—O—Si—, —Ti—O—Ti—, —Al—O—Al—) and remove excess solvent.

In some embodiments where a porosity forming agent is included in the sol-gel composition reaction products formed by oxidation of the porosity forming agents are removed upon heating leaving behind a porous film with a low refractive index. In some embodiments, where silica nanoparticles are included in the sol-gel composition, a combination of nanoparticles and the polymerized network may form a porous structure in the conformal coating due to particle packing in presence of the polymerized network that acts as a binder to support and bond the particles together as well as bond the conformal coating to the substrate.

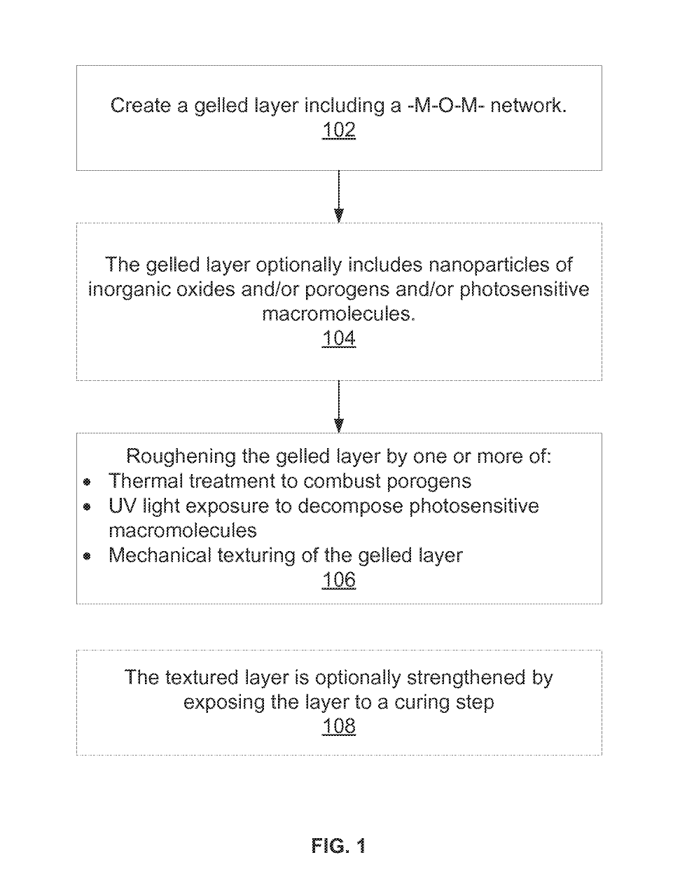

FIG. 1 is a flow chart of one embodiment of a method for forming a coating on a substrate according to some embodiments. The coating may be an oxide coating. Exemplary conformal oxide coatings include silicon oxide, titanium oxide, zirconium oxide, aluminum oxide, tantalum oxide, hafnium oxide, chromium oxide, tin oxide, and the like. At block 102, a sol-gel composition comprising at least one solidifier is prepared.

In some embodiments, the sol-gel composition may be prepared by mixing a film forming precursor, an acid or base containing catalyst, and a solvent system containing alcohol and water to form a reaction mixture by at least one of a hydrolysis or polycondensation reaction. The reaction mixture may be stirred at room temperature or at an elevated temperature (e.g., 50-60 degrees Celsius) until the reaction mixture is substantially in equilibrium (e.g., for a period of 24 hours). The reaction mixture may then be cooled and additional solvent added to reduce the ash content if desired.

In some embodiments, the solidifier may be added to the reaction mixture prior to stirring the reaction mixture. However, it is generally preferable to add the solidifier to the reaction mixture as close to application of the sol-gel composition to the substrate as possible so as to avoid premature gelation or solidification of the of the sol-gel composition prior to or during application.

Examples of the solidifier may include gelatin, polymers, silica gel, emulsifiers, organometallic complexes, charge neutralizers, cellulose derivatives, and combinations thereof.

Gelatin is generally a translucent, colorless, brittle solid derived from the hydrolysis of collagen by boiling skin, ligaments and tendons. Exemplary gelatins are commercially available from SIGMA-ALDRICH®.

Examples of suitable polymers may include sodium acrylate, sodium acryloyldimethyl taurate, isohexadecane, polyoxyethylene (80) sorbitan monooleate (commercially available under the tradename TWEEN® 80 from ICI Americas Inc.), polyoxyethylene (20) sorbitan monostearate (commercially available under the tradename TWEEN® 60 from ICI Americas Inc.), laureth-7, C13-14 Isoparaffin, hydroxyethyl acrylate, polyacrylamide, polyvinyl butyral (PVB), squalane, polyalkylene glycols, and combinations thereof. Exemplary polymers are available under the tradenames SIMULGEL® 600, SIMULGEL® EG, SEPIGEL® 305, SIMULGEL® NS, CAPIGEL™ 98, SEPIPLUS™ 265 and SEPIPLUS™ 400 all of which are commercially available from SEPPIC.

Examples of suitable polyalkylene glycols include polyalkylene glycols where the alkyl group may be any alkyl group, such as, methyl, ethyl, propyl, butyl, pentyl, hexyl, heptyl, octyl, nonyl, decyl, etc. One exemplary polyalkylene glycol includes polyethylene glycol (PEG). Preferable polyethylene glycols have a molecular mass between 200 and 1,000.

Silica gel is a granular, viscous, highly porous form of silica made synthetically from sodium silicate. Exemplary silica gels are commercially available from SIGMA-ALDRICH®.

Exemplary organometallic complexes may include a hydrophilic sugar-like head portion and a lipophilic hydrocarbon tail couple by an organometallic fragment (e.g., pentacarbonyl [D-gluco-hex (N-n-octylamino)-1-ylidene] chromium). Other exemplary organometallic complexes include low-molecular mass organic gelator (LMOG).

Exemplary charge neutralizers include ammonium nitrate.

Exemplary cellulose derivatives include hydroxypropyl cellulose (HPC), hydroxypropyl methylcellulose (HPMC), nitrocellulose, hydroxypropyl ethylcellulose, hydroxypropyl butylcellulose, hydroxypropyl pentylcellulose, methyl cellulose, ethylcellulose, hydroxyethyl cellulose, various alkyl celluloses and hydroxyalkyl celluloses, various cellulose ethers, cellulose acetate, carboxymethyl cellulose, sodium carboxymethyl cellulose, calcium carboxymethyl cellulose, among others. Exemplary cellulose derivatives are commercially available under the tradenames KLUCEL® hydroxypropylcellulose, METHOCEL™ cellulose ethers, and ETHOCEL™ ethylcellulose polymers.

The solidifier may be added in an amount sufficient to expedite the sol-gel transition point without solidifying the sol prior to application to the substrate. The solidifier may be added in an amount such that the sol-gel transition occurs when the sol-gel composition comprises less than 50% solid by weight. The solidifier may be added in an amount such that the sol-gel transition occurs when the sol-gel composition comprises less than 40% solid by weight. The solidifier may be added in an amount such that the sol-gel transition occurs when the sol-gel composition comprises less than 30% solid by weight. The solidifier may be added in an amount such that the sol-gel transition occurs when the sol-gel composition comprises less than 20% solid by weight. The solidifier may be added in an amount such that the sol-gel transition occurs when the sol-gel composition comprises less than 10% solid by weight.

The solidifier may comprise at least 0.0001 wt. %, 0.001 wt. %, 0.01 wt. %, 0.1 wt. % or 1 wt. % of the total sol-gel composition. The solidifier may comprise up to 0.01 wt. %, 0.1 wt. %, 1 wt. % or 5 wt. % of the total sol-gel composition. In some embodiments, the solidifier may comprise between 0.001 wt. % and 1 wt/% of the total sol-gel composition. It should be understood that the amount of solidifier added to the sol-gel composition may be based on factors including molecular weight, reactivity, and the number of reactive sites per molecule all of which may vary from molecule to molecule. It is preferable to lower the percent solids at the sol-gel transition point; while at the same time assuring that the solidifier doesn't induce gelation prior to coating in the liquid phase itself.

The sol-gel composition further includes a film forming precursor which forms the primary structure or network of the gel and the resulting solid coating. The film forming precursor may be a silicon containing precursor, a titanium containing precursor, or an aluminum containing precursor, a zirconium containing precursor, a tantalum containing precursor, a hafnium containing precursor, a tin containing precursor, and the like. Exemplary silicon containing precursors include silane and silicon alkoxide containing precursors. The silicon containing precursor may be in liquid form. Exemplary silicon containing precursors include alkyl containing silicon precursors such as tetraalkylorthosilicate, alkyltrialkoxysilane, alkyltrialkylsilane (where each alkyl group may independently be any alkyl group, such as methyl, ethyl, propyl, butyl, pentyl, hexyl, heptyl, octyl, nonyl, decyl, etc.). Exemplary silane containing precursors or metal alkoxide containing precursors may be selected from the group comprising: tetraethylorthosilicate (TEOS), 3-glycidoxypropyltrimethoxysilane (Glymo), octadecyltrimethoxysilane (OTS), propyltriethoxysilane (PTES), methyltriethoxysilane (MTES), (heptadecafluoro) 1,1,2,2-tetrahydrodecyltrimethoxysilane, hexamethyldisilazane (HMDS), and combinations thereof. Exemplary titanium precursors include titanium alkoxide and titanium chloride precursors. Exemplary aluminum precursors include aluminum alkoxides, aluminum nitrate, aluminum chloride, aluminum acetate, and the like. Exemplary zirconium precursors include zirconium alkoxide and zirconium chloride precursors. Exemplary tantalum precursors include tantalum alkoxide and tantalum chloride precursors. Exemplary hafnium precursors include hafnium alkoxide and hafnium chloride precursors. Exemplary tin precursors include tin alkoxide and tin chloride precursors.

The amount of film forming precursor may comprise at least 1 wt. %, 3 wt. %, 5 wt. %, 7 wt. %, 9 wt. %, 10 wt. %, 11 wt. %, 13 wt. %, 15 wt. %, 17 wt. %, or 19 wt. of the total weight of the sol-gel composition. The amount of film forming precursor may comprise up to 3 wt. %, 5 wt. %, 7 wt. %, 9 wt. %, 10 wt.%, 11 wt. %, 13 wt. %, 15 wt. %, 17 wt. %, 19 wt. %, or 20 wt. % of the total weight of the sol-gel composition. The film forming precursor may be present in the sol-gel composition in an amount between about 1 wt. % and about 20 wt. % of the total weight of the sol-gel composition. The amount of film forming precursor may correspond to 1-5% final ash content in the final sol composition.

The sol-gel composition further includes an acid or base catalyst for controlling the rates of hydrolysis and condensation. The acid or base catalyst may be an inorganic or organic acid or base catalyst. Exemplary acid catalysts may include hydrochloric acid (HCl), nitric acid (HNO₃), sulfuric acid (H₂SO₄), acetic acid (CH₃COOH), p-toluenesulfonic acid (PTSA, CH₃C₆H₄SO₃H) or combinations thereof. Exemplary base catalysts include ammonium hydroxide (NH₄OH) and tetramethylammonium hydroxide (TMAH, C₄H₁₂NOH).

The acid catalyst level may be 0.001 to 10 times the stoichiometric molar precursor (the film forming precursor). The acid catalyst level may be from 0.001 to 0.1 times the molar precursor (the film forming precursor). The base catalyst level may be 0.001 to 10 times the stoichiometric molar precursor (the film forming precursor). The base catalyst level may be from 0.001 to 0.1 times the molar precursor (the film forming precursor). The amount of film acid catalyst level may be from 0.001 to 0.1 wt. % of the total weight of the sol-gel composition. The amount of base catalyst level may be from 0.001 to 0.1 wt. % of the total weight of the sol-gel composition.

The sol-gel composition further includes a solvent system. The solvent system may include a non-polar solvent, a polar aprotic solvent, a polar protic solvent, or combinations thereof. Selection of the solvent system may be used to influence the timing of the sol-gel transition. Exemplary solvents include alcohols, for example, n-butanol, isopropanol, n-propanol (NPA), ethanol, methanol, and other well known alcohols. The amount of solvent may be from 80 to 95 wt. % of the total weight of the sol-gel composition. The solvent system may further include water. The amount of water may be from 0.001 to 0.1 wt. % of the total weight of the sol-gel composition. In some embodiments, water may be present in 0.5 to 10 times the stoichiometric amount need to hydrolyze the precursor molecules.

In step 104, in some embodiments where a porous coating is desired, the sol-gel composition may optionally include a porosity forming agent. The porosity forming agent may include a molecular porogen. The molecular porogen may be a self assembling molecular porogen. Examples of the self assembling molecular porogen may include non-ionic surfactants, cationic surfactants, anionic surfactants, or combinations thereof. Exemplary non-ionic surfactants include non-ionic surfactants with linear hydrocarbon chains and non-ionic surfactants with hydrophobic trisiloxane groups. The self assembling molecular porogen may be a trisiloxane surfactant. Exemplary self assembling molecular porogens may include polyoxyethylene stearyl ether, benzoalkoniumchloride (BAC), cetyltrimethylammoniumbromide (CTAB), 3-glycidoxypropyltrimethoxysilane (Glymo), polyethyleneglycol (PEG), ammonium lauryl sulfate (ALS), dodecyltrimethylammoniumchloride (DTAC), polyalkyleneoxide modified hepta-methyltrisiloxane, or combinations thereof.

Exemplary self assembling molecular porogens are commercially available from Momentive Performance Materials under the tradename SILWET® surfactant and from SIGMA ALDRICH® under the tradename BRIJ® surfactant. Suitable commercially available products of that type include SILWET® L-77 surfactant and BRIJ® 78 surfactant.

The self assembling molecular porogen may comprise at least 0.1 wt. %, 0.5 wt. %, 1 wt. %, or 3 wt. % of the total weight of the sol-gel composition. The self assembling molecular porogen may comprise at least 0.5 wt. %, 1 wt. %, 3 wt. % or 5 wt. % of the total weight of the sol-gel composition. The self assembling molecular porogen may be present in the sol-gel composition in an amount between about 0.1 wt. % and about 5 wt. % of the total weight of the sol-gel composition.

In step 104, in some embodiments where a porous coating is desired, the sol-gel composition may optionally include silica nanoparticles. The nanoparticles may be of various shapes and sizes. Exemplary shapes include spherical, cylindrical, prolate spheroid, and disc shaped. The size of the nanoparticles may vary from 5 nanometers to 100 nanometers in diameter. Exemplary silica nanoparticles are commercially available in sol form under the tradename ORGANOSILICASOL™ from Nissan Chemical America Corporation. Suitable commercially available products of that type include ORGANOSILICASOL™ DMAC-ST, ORGANOSILICASOL™ EG-ST, ORGANOSILICASOL™ IPA-ST, I ORGANOSILICASOL™ PA-ST-L, ORGANOSILICASOL™ IPA-ST-MS, ORGANOSILICASOL™ IPA-ST-ZL, ORGANOSILICASOL™ MA-ST-M, ORGANOSILICASOL™ MEK-ST, ORGANOSILICASOL™ MEK-ST-MS, ORGANOSILICASOL™ MEK-ST-UP, ORGANOSILICASOL™ MIBK-ST and ORGANOSILICASOL™ MT-ST.

In some embodiments, the silica nanoparticles may be generated in-situ. One exemplary sol-gel composition for in-situ generation of silica nanoparticles includes a silane precursor (e.g., TEOS), water, a base catalyst (e.g., TMAH), and an alcohol solvent (e.g. n-propyl alcohol (NPA)). The components may be mixed for twenty-four hours at room or elevated (˜60 C) temperatures as discussed above.

In some embodiments where a porous coating is desired, the sol-gel composition may further include both silica nanoparticles and porosity forming agents to create a distribution of pores. The distribution of pores may comprise a first set of pores formed by combustion of the porosity forming agent nanostructures in the polymeric network or matrix (e.g. the Si—O—Si network) and a second set of pores formed by the voids in particle packing in the polymeric network or matrix.

In step 104, some embodiments where a porous coating is desired, the sol-gel composition may optionally include photosensitive macromolecules. Examples of suitable photosensitive macromolecules include polymers having aromatic moieties and/or caged structures.

The gel coating on the substrate is annealed to form a coating on the substrate. The annealing temperature may be selected based on the chemical composition of the sol-gel compositions, depending on what temperatures may be required to form cross-linking between the components throughout the coating. In some embodiments, the annealing temperature may be in the range of 500 degrees Celsius and 1,000 degrees Celsius. In some embodiments, the annealing temperature may be 600 degrees Celsius or greater. In some embodiments, the annealing temperature may be between 625 degrees Celsius and 650 degrees Celsius. In some embodiments where the sol-gel includes a porosity forming agent, the anneal process removes the porosity forming agent from the gel to form a porous coating.

In step 106, the gelled layer is roughened (i.e. textured) using one of several methods. In a first group of methods, gelled layers that include a porogen can be subjected to a thermal treatment to combust the porogens. The combustion of the porogens will result in a coating with increased porosity and surface roughness. In a second group of methods, gelled layers that include a photosensitive macromolecule can be subjected to a ultra-violet (UV) treatment to decompose the photosensitive macromolecules. The decomposition of the photosensitive macromolecules will result in a coating with increased porosity and surface roughness. In a third group of methods, the gelled layer may be textured using mechanical processes such as mechanical rollers or planar textured surfaces (e.g. embossing). Those skilled in the art will understand that the methods may be used in combination to develop a textured surface. In each case, the surface roughness of the layer should be in the range of 0.4 microns to 5.0 microns.

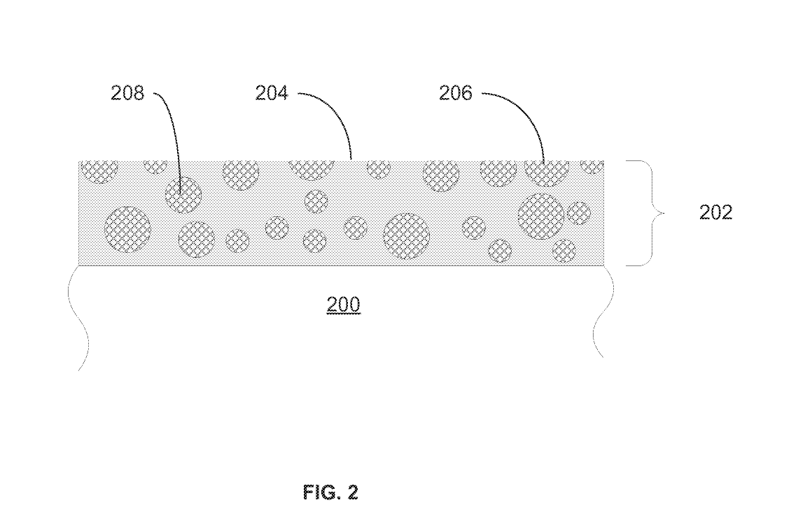

FIG. 2 illustrates a cross-sectional schematic of a substrate with a layer formed thereon. FIG. 2 is meant to depict a substrate, 200, with a layer, 202, formed thereon using a sol-gel process and the layer further includes at least one of porogens, nanoparticles, or photosensitive macromolecules. The layer, 202, includes a matrix, 204, (formed from the gelled material), the matrix including internal porosity, 208, formed from at least one of porogens, nanoparticles, or photosensitive macromolecules, and surface porosity, 206, formed from at least one of porogens, nanoparticles, or photosensitive macromolecules.

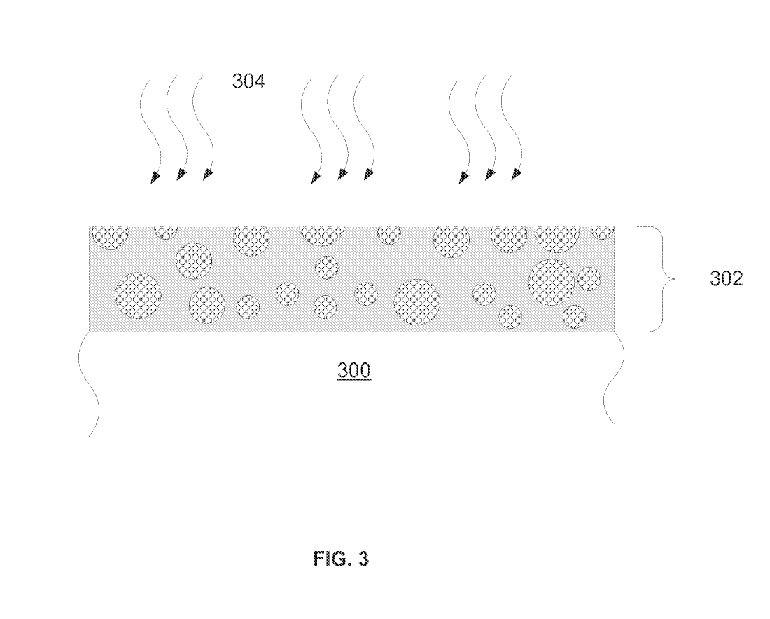

FIG. 3 illustrates a cross-sectional schematic of a substrate with a porous film formed thereon. FIG. 3 is meant to depict a substrate, 300, with a layer, 302, formed thereon using a sol-gel process. To increase the porosity and surface roughness of the layer, the layer, 302, may be exposed to a thermal treatment or a UV treatment, both illustrated as treatment, 304. Thermal treatments will remove the porogens by combustion as discussed previously. UV treatments will remove the photosensitive macromolecules by decomposition as discussed previously. An optional annealing or curing step may be imposed after the treatment to further add mechanical strength to the layer. The curing step may be a thermal curing process, a chemical curing process, or a combination thereof.

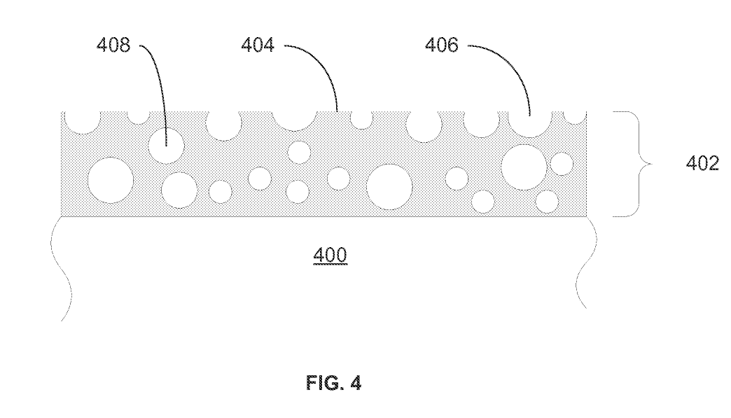

FIG. 4 illustrates a cross-sectional schematic of a substrate with a textured surface formed thereon. FIG. 4 is meant to depict a substrate, 400, with a layer, 402, formed thereon using a sol-gel process. The layer, 402, includes a matrix, 404, (formed from the deposited material), the matrix including internal porosity, 408, and surface porosity, 406. Although illustrated as circles/spheres, those skilled in the art will understand that the pores within the material will generally have irregular shapes. As discussed previously, the size and volume fraction of the porosity within the layer can be influenced by changing the process parameters of the sol-gel process and by incorporating at least one of porogens, nanoparticles, or photosensitive macromolecules.

The surface porosity, 406, is formed by the intersection of pores within the matrix with the surface. For applications where the goal is to produce layers that serve as anti-glare coatings in the visible range, the root mean square (rms) surface roughness should be between 0.4 microns and 5.0 microns. Typically, the layer, 402, has a thickness between 1 micron and 50 microns.

Although the foregoing examples have been described in some detail for purposes of clarity of understanding, the invention is not limited to the details provided. There are many alternative ways of implementing the invention. The disclosed examples are illustrative and not restrictive.

1. A method for forming an anti-glare coating, the method comprising:
forming a gelled layer using a sol-gel process, the process including a transition through a gel point at which an infinite polymer network is formed; and
treating the gelled layer,
wherein the treating creates surface roughness at a surface of the layer, the root mean square (rms) value of the created surface roughness being in the range of 0.4 microns to 5.0 microns.

2. The method of claim 1, wherein the layer further comprises at least one of a porogen, nanoparticles, or photosensitive macromolecules.

3. The method of claim 1, wherein the treating the layer comprises one of a thermal treatment, or an ultra-violet treatment, and wherein the treating creates porosity within the layer.

4. (canceled)

5. The method of claim 1, wherein the layer comprises an oxide network comprising at least one of silicon oxide, titanium oxide, zirconium oxide, aluminum oxide, tantalum oxide, hafnium oxide, chromium oxide, or tin oxide.

6. The method of claim 1, further comprising curing the layer after the treating.

7. The method of claim 6, wherein the curing is one of a thermal curing treatment or a chemical curing treatment.

8. (canceled)

9. The method of claim 1, wherein the layer comprises a porogen and the treatment comprises a thermal treatment.

10. The method of claim 1, wherein the layer comprises a photosensitive macromolecule and the treatment comprises an ultra-violet treatment.

11. The method of claim 1, wherein the layer has a thickness between 1 micron and 50 microns.

12. The method of claim 1, wherein the layer is formed from a film forming precursor comprising one or more of a silicon containing precursor, a titanium containing precursor, or an aluminum containing precursor, a zirconium containing precursor, a tantalum containing precursor, a hafnium containing precursor, chromium containing precursor, or a tin containing precursor.

13. The method of claim 1, wherein the treating comprises a thermal treatment at a temperature between 500 C and 1000 C.

14. The method of claim 13, wherein the treating comprises a thermal treatment at a temperature between 600 C and 650 C.

15. The method of claim, 1 wherein the layer comprises a porogen and the porogen is removed during the treating, the treating comprising a thermal treatment.

16. The method of claim, 1 wherein the layer comprises a photosensitive macromolecule and the photosensitive macromolecule is removed during the treating, the treating comprising an ultra-violet treatment.

17. The method of claim 16, wherein the photosensitive macromolecule comprises at least one of aromatic moieties or caged structures.

18. The method of claim 1, wherein the treating the layer comprises a mechanical treatment.

19. The method of claim 9, wherein the treating the layer comprises a thermal treatment at a temperature sufficiently high to combust the porogen.

20. The method of claim 18, wherein the mechanical treatment comprises one of using textured rollers, or using textured plates.
